(19) United States
(12) Patent Application Publication
(10) Pub. No.: US 2011/0218734 A1
(43) Pub. Date: Sep. 8, 2011

(54) Methods and apparatus for passive tropospheric measurments utilizing a single band of frequencies adjacent to a selected millimeter wave water vapor line

(75) Inventor: Fredrick S. Solheim, Boulder, CO (US)

(73) Assignee: Radiometrics Corporation

(21) Appl. No.: 12/660,906

(22) Filed: Mar. 8, 2010

(51) Int. Cl. G01W 1/00

(52) U.S. Cl. 702/3

(57) ABSTRACT

Apparatus and methods are disclosed for passive millimeter wave measurements to provide tropospheric profiles of temperature, water vapor, cloud liquid water, pressure, and refractivity utilizing a single band microwave receiver operating in the vicinity of the water vapor emission line centered at 183.31 GHz or other millimeter wave water vapor line. Ancillary meteorological measurements may be provided to refine profile outputs. Retrieval method training adapts and refines system output to provide useful information for weather nowcasting and forecasting, aviation safety, transport of pollutants, prediction of fog and other weather phenomena, and radar and optical ducting prediction.

### FIELD OF THE INVENTION

This invention relates to atmospheric profiling apparatus and methods using passive microwave radiometry, and, more particularly, relates to such profiling utilizing continuous and passive remote observations of emissions in the vicinity of a selected millimeter wave water vapor line.

### BACKGROUND OF THE INVENTION

A need exists in the field of atmospheric meteorological parameter measurement to passively, remotely, and continuously measure the tropospheric profiles of thermodynamic parameters as a function of altitude or distance. Such measurements are of value in weather forecasting and nowcasting, aircraft icing condition detection, chemical, biological, and radionuclide transport and dispersal, artillery accuracy, radio ducting characterization, and other applications.

Profiling of tropospheric temperature and water vapor has historically been accomplished using in situ means such as radiosondes, which are of necessity point-in-time and trajectory-in-space applications and therefore generally widely spaced spatially and temporally. Radiosondes are costly, require helium (a nonrenewable resource) or hydrogen (a hazardous flammable gas), and for ongoing atmospheric monitoring require periodic launch (every 12 hours, for example). Weather can change dramatically between these launches, thus degrading the value of radiosonde data in weather forecasting and nowcasting. Moreover, they utilize on-board transmitters and are thus objectionable to military users since they reveal the location of military forces.

Microwave radiometers are now also being utilized to profile tropospheric temperature, water vapor, cloud liquid water, pressure, and refractivity, for example (see U.S. Pat. Nos. 7,353,690, 6,377,207, 6,308,043, 5,526,676 and 4,873,481). However, to accomplish this, operation in multiple wavebands (e.g., 22 to 30 GHz in concert with 51 to 59 GHz) was heretofore required to create profiles. Observations in the vicinity of the 22.235 GHz or 183.3 GHz water vapor line enable profiling of water vapor, observations in the vicinity of the 60 GHz or 118 GHz oxygen feature enable temperature profiling, and the combination of observations in the vicinities of these two frequency bands enables profiling of cloud liquid water. However, to accomplish this, two separate microwave receivers/antenna systems operating simultaneously in multiple wavebands and two separate channels for processing the responses of these receivers are required, thus adding complexity and expense to their manufacture and use.

Heretofore known passive tropospheric microwave and millimeter wave radiometers receive and resolve the emissions of the atmospheric constituents. These measurements can be rendered useless by contamination, or radio frequency interference (RFI), by active sources (transmitters). This is an increasing problem in radiometry, especially at lower microwave frequencies, as these wavebands are being increasingly licensed for active uses. Heretofore, millimeter waveband water vapor profilers have only been applied in dry climates and were considered unusable in any other than these dry climates. Moreover, they have typically been capable of observing only at a limited number of frequencies (for instance, the strong resonance at 183.3 GHz).

Microwave radiometers are generally very sensitive, receiving and resolving signals of a fraction of a billionth of a watt, and therefore any transmission, harmonics or spurious emissions in the receiver waveband contaminates the data and possibly renders it useless. Currently, as noted above, measurements in the vicinity of the 22 GHz water vapor line and the 60 GHz oxygen feature are commonly utilized for such profiling, but these regions of the spectrum have been licensed out for active transmissions. For example, automobile anticollision radars (a site-nonspecific active source) are presently operating in the waveband from 22 to 26 GHz, a waveband widely utilized by water vapor profiling radiometers. Higher frequency wavebands are mostly technologically impractical for active transmission applications, and are therefore substantially free from RFI.

In view of the foregoing, while microwave radiometer receivers have proven useful in determining the amount of atmospheric emission across spectral wavebands for profiling atmospheric temperature and moisture and, based thereon, predicting various parameters related to weather conditions, further adaptation of such receivers and systems could still be utilized.

### SUMMARY OF THE INVENTION

This invention provides passive, simultaneous and remote measurement of tropospheric temperature, water vapor, cloud liquid water, pressure, refractivity profiles and other tropospheric parameters in most all weather conditions from a single waveband millimeter wave radiometry apparatus and methods. Tropospheric measurements are accomplished utilizing a single band of frequencies adjacent to a selected millimeter wave water vapor line. The present invention takes advantage of technical and economical limitations for active transmission uses of high (millimeter wave) frequencies to provide relatively noiseless passive measurement to determine the temperature, water vapor, relative humidity, pressure, and refractivity profiles of the atmosphere. The apparatus and methods of this invention operate in millimeter wavebands (microwave wavelengths shorter than 1 centimeter) where there are presently no active sources of emission and therefore no RFI.

Passive methods for creating profiles of temperature, water vapor, cloud liquid water, pressure, and refractivity in the troposphere with a single band microwave receiver are shown herein. The methods utilize the passive microwave radiometer apparatus of this invention, operating (for example) in the vicinity of the water vapor emission line centered at 183.31 GHz (other millimeter wave water vapor lines could be utilized). These measurements may optionally be utilized in concert with ancillary meteorological measurements and/or other information such as satellite or GPS observations, surface meteorology and climatology, and numeric weather models to improve accuracy and resolution. The methods and apparatus provide useful information for weather nowcasting and forecasting, aviation safety (detecting and ranging aircraft icing conditions, for example), transport of pollutant, biological, chemical, and/or nuclear agents, prediction of fog and other weather phenomena such as microbursts, and radar and optical ducting in the tropospheric boundary layer.

The apparatus and methods involve less complexity, and are thus less expensive to manufacture, while still providing accurate and constant measurement capabilities across the selected waveband to thereby passively measure atmospheric parameters and changes in such parameters. Since profiling of tropospheric temperature, water vapor, cloud liquid water, pressure, and refractivity is accomplished in a single waveband (in the vicinity of the 183.31 GHz or higher frequency water vapor emission lines) utilizing hyperspectral sampling and methods of interpretation of this invention, only a single millimeter wave receiver and antenna system is needed. Moreover, because millimeter wave receiver components of this invention scale as wavelength, the invention is much smaller and simpler than heretofore known and utilized techniques, making it suitable for a greater variety of applications. Additionally, utilization of narrower antenna bandwidths is made possible.

More particularly, the methods of this invention provide determination of selected atmospheric characteristics utilizing signals from a passive radiation emission measurement device. A large number of frequencies across a single millimeter waveband adjacent to a selected predictable atmospheric millimeter wave water vapor emission line are remotely received at the measurement device, and an output indicative thereof is provided. As used herein, the terminology “adjacent to” includes the millimeter water vapor line itself and a range of neighboring frequencies. The output is processed to provide brightness temperature measurement data corresponding to the output, and the measurement data is processed to provide thermodynamic profiles of interest.

The method preferably includes additional steps related to processing of the measurement data including the collection of training sets including thermodynamic profiles and modeled radiometer correlated observables and utilizing the training sets to train a retrieval method. The retrieval method is then utilized to process the measurement data.

The apparatus of this invention for passive tropospheric measurement utilizing a single band of frequencies adjacent to a selected millimeter wave water vapor line includes a single millimeter wave emission receiver for sensing signals indicative of brightness temperatures in a millimeter waveband adjacent to a selected predictable atmospheric thermal radiation emission line. The receiver provides output signals indicative of the sensed signals. A link for connection with various data sources selected from a plurality of available sources is provided to receive data signals from the sources. A processor receives and processes the output signals from the receiver and the data signals at the link. A trainable retrieval stage at the processor trains and applies retrieval coefficients or functions to processed signals and, responsive thereto, an output indicative of selected atmospheric characteristics of interest is obtained. Means at the processor communicates the output.

It is therefore an object of this invention to provide methods and apparatus for passive tropospheric characteristic measurement and profiling utilizing a single band of frequencies adjacent to a selected millimeter wave water vapor line.

It is another object of this invention to provide passive simultaneous remote measurement of tropospheric temperature, water vapor, cloud liquid water, pressure, and refractivity profiles and other tropospheric parameters in most all weather conditions from a millimeter wave radiometry system.

It is still another object of this invention to provide apparatus and methods for passive tropospheric measurements utilizing a single band of frequencies and operating in millimeter wavebands where there is virtually no radio frequency interference.

It is yet another object of this invention to provide methods for creating profiles of temperature, water vapor, cloud liquid water, pressure, and refractivity in the troposphere with a single-band microwave receiver.

It is still another object of this invention to provide methods and apparatus for generating useful information for weather nowcasting and forecasting, for aviation safety, for transport of pollutant, biological, chemical, and/or nuclear agents, for prediction of fog and other weather phenomena, and for radar and optical ducting analysis in the tropospheric boundary layer.

It is yet another object of this invention to provide apparatus and methods for passive tropospheric characteristic measurement and profiling that are less complex, and thus less expensive to manufacture and utilize, while still providing accurate and ongoing measurement capabilities.

It is another object of this invention to provide a method for determination of selected of atmospheric characteristics utilizing signals from a passive radiation emission measurement device that includes the steps of remotely receiving a large number of frequencies across a single waveband adjacent to a selected predictable atmospheric millimeter wave water vapor emission line at the measurement device and providing output indicative thereof, processing the output to provide brightness temperature measurement data corresponding to the output, and processing the measurement data to provide thermodynamic profiles of interest.

It is still another object of this invention to provide an apparatus for passive tropospheric measurement utilizing a single band of frequencies adjacent to a selected millimeter wave water vapor line that includes a single millimeter wave emission receiver for sensing signals indicative of brightness temperatures in a millimeter waveband adjacent to a selected predictable atmospheric thermal radiation emission line and providing output signals indicative thereof, a link for connection with various data sources selected from a plurality of available sources to receive data signals therefrom, a processor receiving and processing the output signals from the receiver and the data signals at the link, the processor including a trainable retrieval stage for training and applying retrieval coefficients or functions to processed signals and responsive thereto obtaining an output indicative of selected atmospheric characteristics of interest, and means associated with the processor for communicating the output.

It is yet another object of this invention to provide a method for making passive tropospheric measurements utilizing a single band of frequencies adjacent to a selected millimeter wave water vapor line that includes the steps of remotely receiving a large number of frequencies across a single millimeter waveband adjacent to a selected predictable atmospheric wave water vapor emission line at the measurement device and providing output indicative thereof, processing the output to provide brightness temperature measurement data corresponding to the output, collecting training sets including thermodynamic profiles and modeled radiometer correlated observables, training a retrieval method utilizing the training sets, and processing the measurement data utilizing the retrieval method to provide thermodynamic profiles of interest.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a graphic illustration of the atmospheric absorption (emission) spectrum from 160 to 200 GHz;

FIG. 2 is a block diagram of the preferred radiometer receiver apparatus of this invention;

FIG. 3 is a block diagram illustrating operation of the radiometer apparatus' signal processing system;

FIG. 4 is a graph showing several days' brightness temperature observations across 15 channels utilizing the apparatus and/or methods of this invention;

FIGS. 5a through 5c are graphic comparisons of retrieved clear-sky profiles utilizing the apparatus and/or methods of this invention compared with radiosonde data;

FIG. 6 is a flow chart illustrating methods in accord with this invention for forward modeling radiometer and other observable parameters from a priori or modeled atmospheric thermodynamic state parameters, and, together with a corresponding set of atmospheric state profiles, generating a retrieval algorithm; and

FIG. 7 is a flow chart illustrating methodology in accord with this invention for millimeter wave tropospheric profiling.

### DESCRIPTION OF THE INVENTION

The Earth's atmosphere emits thermal radiation in all wavebands, blackbody radiation from both atmospheric atomic and molecular constituents and clouds and hydrometeors. This emitted thermal radiation is reabsorbed and re-emitted by these atomic and molecular species and clouds and hydrometeors. Prominent spectral peaks are thus caused by absorption lines or, equivalently, emission lines, of atmospheric water vapor, oxygen, carbon dioxide, and other atmospheric gasses. Regions of the spectrum between these peaks, called transmission windows, have lower signal absorption. Radiation in window regions emanates from the tails of resonances in the vicinity, from minor constituents such as ozone, and from emissions from nonpolar constituents such as molecular nitrogen. Together this is called the microwave/millimeter wave continuum. The continuum due to other than water vapor and liquid water is relatively constant in time and can be estimated with a barometric pressure measurement, as the concentrations in the emitting constituency are relatively constant.

The shape of emission lines is a function of local pressure (altitude) and temperature (referred to as pressure broadening). Thus, the altitude of the emitting constituent can be determined by its emission line shape. This shape is described by the VanVleck-Weiskopf model:

$${F}_{v}^{″} = f [ \frac{γ}{{( f - {f}_{o} )}^{2} + {γ}^{2}} + \frac{γ}{{( f + {f}_{o} )}^{2} + {γ}^{2}} ]$$

where γ is the line half-width, a function of temperature and pressure, fₒ is the line center frequency, and the double prime indicates the imaginary (emissive) component of the line shape factor.
   The strength of this line is proportional to the density of the emitting constituent and its physical temperature.

Underlying the spectral emission lines of the troposphere is a continuum of emission. The absorption (equals emission by Kirchoff's law for a steady state atmosphere) of the continuum up to about a terahertz in frequency can be expressed as:

α_{continuum}(ν)=(CₛP_{H}_{₂}_{O}²θ^{10.5}+C_{f}P_{H}_{₂}_{O}P_{dry}θ²)ν²

where
α_{continuum}(f) is the absorption at frequency f,

$$θ = \frac{300 K}{T , Kelvins} ,$$

the inverse temperature,
Cₛ is a constant, 1.5×10⁻⁷ cm⁻¹ bar⁻² GHz⁻²
C_{f} is a constant, 4.74×10⁻⁹ cm⁻¹ bar⁻² GHz⁻²
P_{H}_{₂}_{O} is the partial pressure of water vapor,
and P_{dry} is the partial pressure of the dry air constituency.

The downwelling radiation reaching the earth is defined as “brightness temperature,” the temperature of a blackbody emitting equivalent radiation, and can be expressed by Chandrasekhar's Radiative Transfer Equation (hereinafter referred to as RTE):

T_{b}(f)=T_{c}(f)exp(−τ_{∞}(f))+∫₀^{∞}T(s)α(f,s)exp(−τₛ(f))ds
where τₛ(f) is the total opacity from the surface to altitude s and may be along a path other than zenith:

τₛ(f)=∫₀^{s}α(f,s′)ds′

and
T_{b}(f)=the brightness temperature,
T_{c}(f) is the cosmic background radiation from the Big Bang,
T(s) is the physical temperature at position s
s is the position of the emitting parcel, can be along an elevated path, and
α(f,s) is the absorption at frequency f and position s.

In accord with the Rayleigh-Jeans long wavelength approximation to the Planck function, a perfect emitter in the microwave region (absorption approaching infinity) radiates a brightness temperature equal to its physical (or kinetic) temperature. Passive microwave and infrared radiometer receivers are able to determine the amount of atmospheric emission across spectral wavebands. Contained in this emission, as a function of frequency and of elevation angle of observation, is information on the vertical distribution of the absorbers and other meteorological parameters. The intensity of the received radiation across absorptive spectral features is dependent upon its physical temperature, the altitude of its emission, and the intervening absorption.

Profile and range information on the thermodynamic parameters of the atmosphere can be passively determined from ground-based radiometric measurements by several standard means such as variable attenuation across spectral features, angular scanning in a vertical plane, and/or mapping pressure broadening of emission lines. Frequency scanning is required at a large number of pertinent frequencies for measurement of variable attenuation as a function of frequency across spectral features and pressure broadening of spectral features, and information content is slightly enhanced by including angular scanning.

Variable attenuation as a function of frequency across resonance features of atmospheric constituents can be measured by radiometers and this information mathematically processed to obtain profile information. For instance, at the center of lines (for example, the assemblage of oxygen resonances centered at 60 GHz), absorption is high and the downwelling radiation reaching the radiometer originates in the lowest several hundred meters of the atmosphere. At frequencies removed from the center of this feature, the absorption is less and the radiation originates from a thicker layer. By observing at successively less opaque frequencies (greater optical depth), information is obtained from higher and higher altitudes or greater and greater ranges. The signals measured at these differing frequencies can be mathematically inverted for range information on atmospheric thermodynamic parameters and atmospheric features.

Observing at numerous elevation angles relative to the horizon at a fixed translucent or opaque frequency generates height information, as at low elevation angles the downwelling radiation originates from altitudes lower than that for higher elevation angles. Combining angular information with frequency scanning recovers additional information on the thermodynamic profile of the atmosphere.

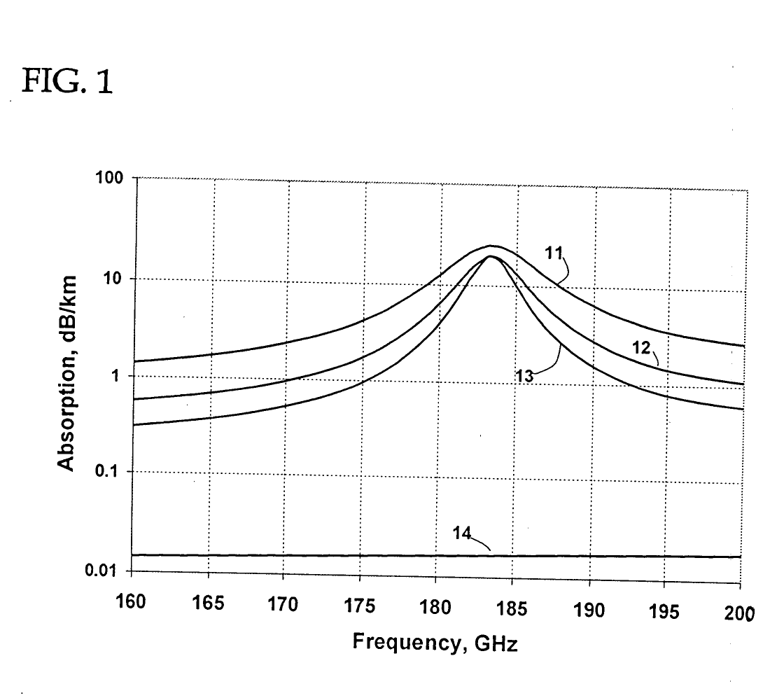

At tropospheric pressures, atmospheric resonances are pressure broadened in width (see FIG. 1, for example), the higher the pressure (lower altitude) and temperature the more the spectral emission lines are broadened. The spectrum across a translucent emission line received by a microwave radiometer consists of contributions from all altitudes. Measuring line shape of downwelling radiation by sampling at a large number of frequencies across the broadened line provides, with application of appropriate mathematical processing, a density profile of the emitting atmospheric species as a function of altitude or range.

Continuum intensity is approximately proportional to frequency squared. This behavior differs from the spectral lines and therefore enables the continuum contribution to emission to be separated from the spectral features. Also having a roughly frequency squared emission spectrum is liquid water. The continuum contribution is small and due to well-mixed atmospheric atomic and molecular constituents, and can thus be estimated or calculated. The liquid water emission, however, is large. Characterizing (measuring) the emission spectrum across the waveband around 183.31 GHz or in the vicinity of other millimeter wave water vapor lines at a large number of separate adjacent frequencies enables the separation of the liquid water contribution from that of water vapor and other constituents.

The process of inverting the observational data of microwave and infrared spectral power and surface meteorology into the desired tropospheric parameters is called “retrieval” of these parameters. These methods determine the state of the atmosphere from the measurements of the observing system. This determination can be accomplished using a number of mathematical methods, for example linear and quadratic regressions, optimal estimation, artificial neural networks, and Bayesian and Newtonian iterative methods. These methods require “training” the retrieval system upon an ensemble of possible a priori atmospheric states and their correlated observables from the radiometric profiling system. The correlated radiometric observables can be obtained by forward modeling brightness temperatures from atmospheric profiles of temperature and other meteorological parameters, measured or estimated. This training enables recognition of atmospheric states from radiometric and other observations using the retrieval method. Retrievals based solely upon physical modeling of the atmosphere are also possible, but inclusion of a priori climatological data from radiosondes or the like in the training ensemble increases the accuracy and skill of the retrieval methodology by limiting the possible atmospheric states to those that physically occur. Inclusion of meaningful data from other observing systems can also increase the retrieval skill.

The atmospheric spectrum in the region of the 183.31 GHz water vapor line is shown in FIG. 1. The spectral power in typical measurements of this type can contain information on the distribution of water vapor, temperature, cloud liquid water, pressure, and refractivity. Three profiles are shown in FIG. 1, representing the spectral profile of the water vapor line at three altitudes. Profile 11 is representative of the line profile at sea level, profile 12 is at 10,000 feet above sea level, and profile 13 is at 18,000 feet above sea level. The underlying continuum of emission is shown by line 14.

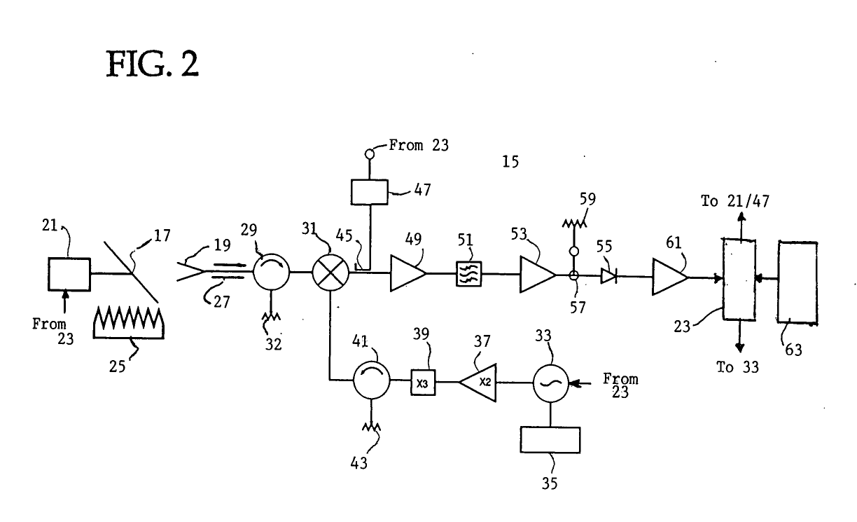

The preferred embodiment 15 of the apparatus of this invention is illustrated in FIG. 2 and may generally be described as a highly accurate and sensitive multiple frequency microwave radiometer receiver capable of hyperspectral sampling, receiving a large number of frequencies in a band adjacent to or across a selected atmospheric millimeter wave water vapor line (centered at 183.31 GHz, for example). While a specific embodiment is shown, receiver architecture can be variously configured, including, for example, direct amplification and filtering into the desired frequencies, downconverting and separating the downconverted signal into a number of filtered sub-bands, and frequency agile tuning of selected frequencies by the receiver across the desired band. Because of the large number of frequencies economically available to a frequency agile synthesized radiometer and the accuracy of double sideband downconversion architecture, this architecture is preferred over other architectures and is adopted in FIG. 2.

The preferred embodiment utilizes a frequency agile synthesizer-based direct downconversion microwave radiometer receiver system capable of tuning across the 170 to 183.3 GHz millimeter waveband. A frequency agile synthesizer is an oscillator device capable of tuning a large number of frequencies by digital or analog control, and referenced to a stable frequency source. The preferred tuning range herein can utilize a low side of the 183.31 GHz line (e.g., 170 to 183.3 GHz) and/or the high side (183 to 200 GHz). Other configuration could use millimeter wave frequency bands adjacent to other water vapor lines such as the 325 GHz, 390 GHz, 449 GHz or 557 GHz line.

The architecture of the apparatus 15 is configured to provide a millimeter wave radiometry system. A shown in FIG. 2, microwave emissions emanating from water vapor and other constituencies of the atmosphere are reflected by microwave mirror 17 and directed to antenna system 19. Mirror 17 can be rotated about a horizontal axis by stepper motor 21 for elevation control responsive to control signals from signal and control processor 23 such that the field of view of antenna 19 can be directed skyward at various angles or toward blackbody 25. Increasing the number of independent measurements and resolution of the retrieved profiles by observing at angles off zenith as well as at the zenith is preferred. Blackbody 25 is at a measured physical temperature and therefore emitting a known spectrum of microwave radiation.

Atmospheric signal from antenna 19 is then conducted into rectangular waveguide 27 of size WR5. Waveguide isolator 29 allows signal passage from antenna 19 through to subharmonically pumped balanced mixer 31, but disallows radio frequency energy to pass from mixer 31 back to antenna 19, the energy being directed into resistive load 32 (in the case of a junction isolator being implemented; the signal would be simply reflected back if a Faraday isolator were implemented instead). Signals are fed to mixer 31 from tunable local oscillator 33.

Oscillator 33 is phase-lock looped in the architecture of a synthesizer and is frequency stabilized via stable frequency reference 35. Oscillator 33 is capable of tuning from about 14 GHz to 15.3 GHz, its output frequency controlled by processor 23. Output of oscillator 33 is multiplied up to a range of 83 GHz to 91.9 GHz by doubler-amplifier 37 and frequency tripler 39. The multiplied output is then passed through waveguide isolator 41 to decouple the synthesized frequency source from the input to subharmonic mixer 31. Passed back (reflected) energy is directed by isolator 41 to resistive load 43 in the case of a junction isolator being implemented. Since mixer 31 is subharmonically pumped, antenna signals are mixed at twice the synthesized frequency signal. Filterbank architecture (20 cavity filters, for example) could be utilized instead of the synthesizer architecture 33 (post down-conversion, a number of available filter types could be used).

Mixer 31 thereby downconverts received atmospheric signals in the 170 GHz to 183.3 GHz band to a baseband intermediate frequency (IF) bandpass of about zero to 500 MHz. Coupler 45 injects a highly stable known signal from noise generating diode 47 that is intermittently activated under control from processor 23 as a gain reference for apparatus 15. Output signals from mixer 31 and the noise signal from diode 47 are amplified at amplifier 49 and then filtered at bandpass filter 51 to a double sideband frequency band of 30 MHz to 500 MHz. This filtered signal is then amplified at amplifier 53, the output of which is received at detector diode 55. Junction 57 is provided to connect 50 ohm resistive load 59 in parallel to the signal path. Resistive load 59 allows a current path to ground for detector diode 55. Output signal from detector diode 55 is again amplified at amplifier 61 and output to processor 23.

Ancillary surface meteorological measurements of temperature, barometric pressure, and relative humidity are provided and signals indicative thereof are received at processor 23 through link 63. Measurement of the temperature of the base of cloud, if present, may also be taken using, for example, an infrared noncontact thermometer, and introduced at processor 23 through link 63. All ancillary meteorological data may be gathered using on-site instrumentation or may be provided utilizing off-site resources. Other data may be introduced through link 63. Examples of other data include data from observing systems providing GPS path delay, other surface meteorological data including winds, radiosonde data, satellite data, and cloud motion data, and may further include the time series of all of these data types.

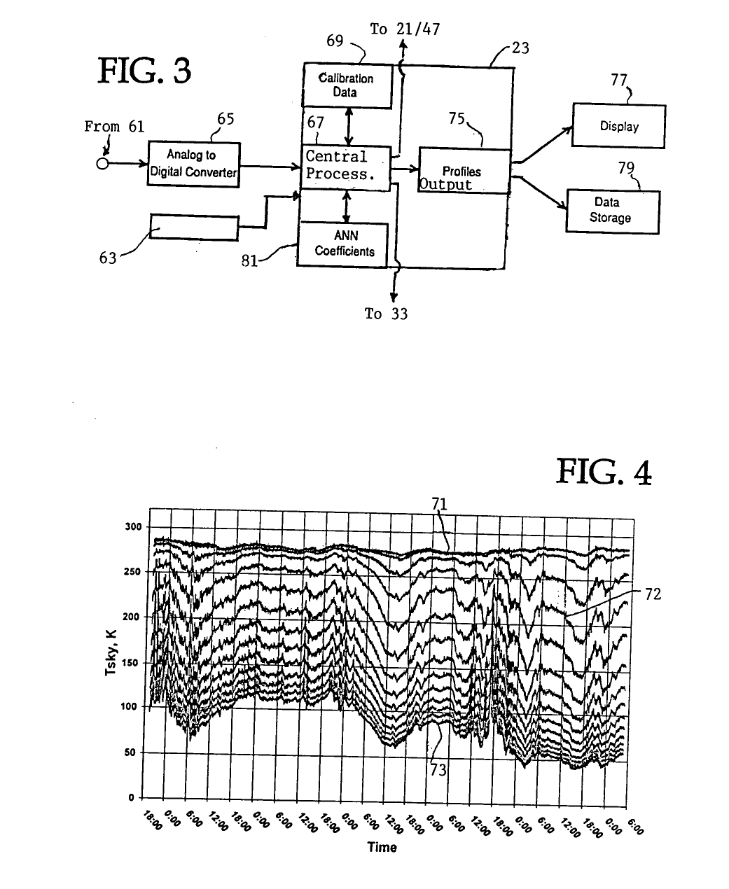

The operational architecture of signal and control processor 23 is illustrated in FIG. 3. Analog to digital converter 65 makes precise measurements of analog voltages from amplifier 61 and produces digital output representing the amplitude of the analog voltages received. Voltages are measured for the various states of the microwave receiver, including at all frequencies observed, with the antenna field of view directed at blackbody 25, at the sky, and with noise diode 47 on and off. These digitized measurements at each frequency are processed at central processing 67 into sky brightness temperature measurement data. Brightness temperature is a term of radiometric art defined as the physical temperature of an ideal blackbody that would produce the same radiation intensity observed by the radiometer receiver. This brightness temperature data is calculated in central processing 67 using receiver calibration data at storage 69 including the gain and offset of the radiometer receiver determined by observations of blackbody 25 reference signals and noise diode 47 reference signals.

An example of several days of brightness temperatures for 15 frequency channels in the millimeter wave band in the vicinity of the water vapor spectral line at 183.3 GHz is shown in FIG. 4. Frequencies such as that identified at 71 at 183.3 GHz are higher in temperature, as emissions at these frequencies are more intense and originate in lower (warmer) regions of the atmosphere. Frequencies such as that identified at 72 at 180 GHz are somewhat removed from the line center and the associated emissions originate from higher in the atmosphere and are colder. Frequencies far removed from the line center such as that identified at 73 at 170 GHz penetrate through the atmosphere and the associated emissions originate from all altitudes and outer space.

Central processing 67 then further processes these brightness temperatures into zenithal and/or off-zenith profiles or ranges of tropospheric thermodynamic parameters including temperature, water vapor density, relative humidity, cloud liquid water, refractivity, and pressure, these profiles maintained at memory/output 75. Processing of brightness temperatures into profiles or ranges, known as retrieval, can be accomplished through any of a number of mathematical methods as heretofore noted, including linear or quadratic regression, Bayesian maximum probability, iterative methods such as Newtonian iteration and those of Mustafa Chahine, artificial neural networking (ANN), maximum likelihood, and direct physical retrieval. Most methods increase retrieval skill by utilizing a priori information on the retrieved profiles from sources such as radiosondes or numerical models. Some retrieval methods are employed on a purely physical basis, utilizing radiative emission and propagation models, so-called radiative transfer models. Retrieved profile data is then processed for appropriate signal output to display 77 and/or to data storage 79.

In the preferred embodiment of this invention, retrieval is accomplished using artificial neural networking (ANN). ANN coefficients stored and updated at ANN processing stage 81 are applied to the brightness temperatures by central processing 67. ANN simulates a simple brain consisting of a large number of neural nodes with neural connections that trigger above certain signal thresholds. Inputs at a number of sensory channels in stage 81 produce corresponding signals at a number of output channels. In the case of retrieval of tropospheric profiles of temperature, water vapor density, relative humidity, cloud liquid water, pressure, and refractivity in the troposphere, the inputs include the radiometrically measured brightness temperatures and possible ancillary measurements through link 63 such as surface pressure, temperature, and relative humidity, GPS delay measurements, cloud base height and temperature measurements, as well as other correlated measurements. ANN stage 81 is “trained” to recognize the inputs and accordingly output the correlated profiles parameter set for temperature, water vapor, relative humidity, cloud liquid water, pressure, and refractivity profiles. Thus trained, ANN stage 81 and central processing 67 then output the above mentioned profiles of atmospheric parameters such as temperature, water vapor density, relative humidity, cloud liquid water, pressure, and refractivity at output 75 in numerical and/or graphical form for display 77 and/or data storage 79.

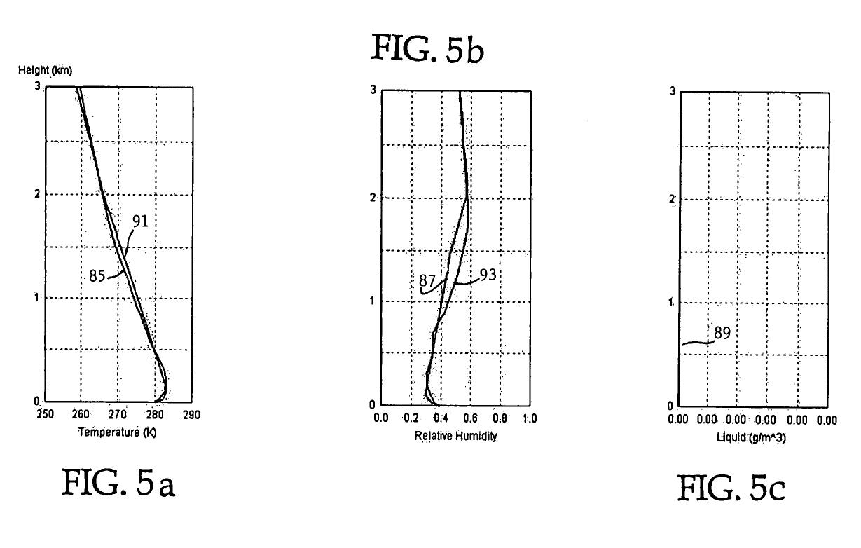

FIGS. 5a through 5c show exemplary data display of profiles of temperature 85, water vapor 87, and cloud liquid water 89 retrieved by the apparatus 15 of this invention as compared with concurrent radiosonde data (temperature at 91 and water vapor at 93). Note that radiosondes do not profile cloud liquid water, and in the example in FIG. 5c no liquid clouds were present.

A “training set” consists of an ensemble of radiometric and ancillary atmospheric observables such as brightness temperatures, surface meteorology, and other correlated measurable parameters, and the matching correlated atmospheric profiles of temperature, water vapor, relative humidity, cloud liquid, pressure, and refractivity. These profiles can also include composite variables such as T*alpha of Chandrasekhar's RTE, the mathematical product of temperature and atmospheric absorption at each altitude. Such composite variables can be more closely physically related to the radiometer observable, as they are the kernel of the brightness temperature equation. Composite variables can be the product, sum, and/or quotient of quantities whose characteristics can be observed or otherwise determined by radiometers. An example of such an observable is the product of temperature and absorption T(s)α(f,s), expressing the power emitted at position s in the integral (quadrate) term of Chandrasekhar's RTE. Inspection of the RTE reveals it to contain the cosmic background radiation term plus a typically dominant integral term consisting of the source T(s)α(f,s) quantifying antifying radiation from distance s and an exponential term reflecting the absorption of the intervening atmosphere. The contribution to downwelling brightness temperature from the 2.7K Cosmic background radiation is small and quite predictable. If this term is ignored in the RTE, we can write the brightness temperature as:

T_{b}(f)=∫₀^{∞}T(s)α(f,s)exp(−τₛ(f))ds=∫₀^{∞}T(s)ρ(h)κ(f)exp(−τₛ(f))ds

where ρ(s) is the density of a microwave radiation emitting constituent at distance s from the radiometer receiver, and κ(f) is the frequency dependent absorption coefficient of that constituent. The remaining (exponential) term in the RTE integral expresses the exponential attenuation of the intervening atmosphere between the radiating source and the radiometer.

In this example, therefore, the brightness temperature is directly related to the composite variable T(s)α(f,s). Retrieving this composite variable is therefore more representative of the physical basis of radiation emission and downwelling radiation than is, for instance, retrieving T(s) as the signal radiated at any altitude is proportional to this composite variable. Retrieving on this composite variable is therefore expected to offer more skill in retrievals. The variables can be subsequently separated into their constituent parts with known absorption coefficients, the Perfect Gas Law, the Hydrostatic Equation, and other applicable physical laws or known parameters.

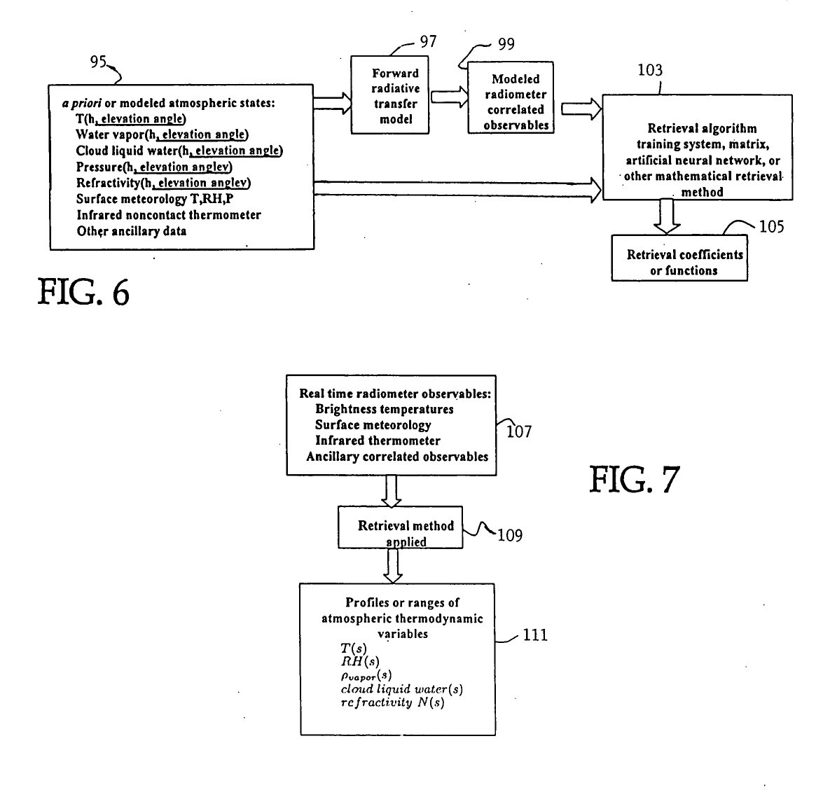

The correlated set of brightness temperatures is calculated from radiosonde or other thermodynamic profiles as shown in FIG. 6. An ensemble of atmospheric thermodynamic parameter data 95 (modeled or a priori data including information such as climatological and historical data, historical data from ancillary observing systems, physical models and the like) and including radiosonde soundings data and/or composite variables is processed through a microwave radiative transfer forward model 97 (such as that described in NOAA Technical Memorandum ERL-WPL-213 or known line-by-line infrared radiative transfer models). Quality control is utilized on the radiosonde data before they are included in the ensemble to ensure that the data are good and the radiosonde has not malfunctioned. The output of this process provides a spectrum of brightness temperatures, surface meteorology, and other parameters for each of the atmospheric states contained in the atmospheric soundings. In the case of the instant invention involving microwave radiometry, this forward modeling process generates a correlated ensemble of radiometric brightness temperatures 99 at various frequencies between 170 and 183.31 GHz (sensitive to atmospheric profiles such as water vapor and temperature among others). Each of the set of forward modeled observables in this ensemble of modeled observables corresponds to training set retrievables (thermodynamic profiles) at 95 consisting of the various atmospheric parameters.

Radiosondes typically report pressure, temperature, relative humidity and wind direction and velocity. To obtain water vapor density from radiosonde or other temperature and humidity profile records, the Goff-Gratch equation is utilized. Over water, the formulation is:

$${log}_{10} {e}_{s} ( T ) = - .7903 ( {T}_{s} / T - 1 ) + 5.028 {log}_{10} ( {T}_{s} / T ) - 1.382 \times {10}^{- 7} ( {10}^{11.34 ( 1 - T / {T}_{s} )} - 1 ) + 8.133 \times {10}^{- 3} ( {10}^{- 3.491 ( {T}_{s} / T - 1 )} - 1 ) + {log}_{10} {e}_{s} ( {T}_{s} )$$

And over ice is:

log₁₀ eᵢ(T)=−9.097(Tₛ/T−1)−3.567 log₁₀(T₀/T)+0.8768(1−T/T₀)+log₁₀ eᵢ(T₀)

where
eₛ is the saturation vapor pressure over water,
eᵢ is the saturation vapor pressure over ice,
eₛ(Tₛ)=1013.2 mb,
T is temperature (Kelvins),
Tₛ=373.16K, the STP steam point,
T₀=273.16K, the STP ice point,
mᵥ is the molecular weight of water=18 g/mole
L_{c} is the latent heat of condensation (vaporization)=2.5×10¹⁰ ergs/g,
and R is the universal gas constant=2.87×10⁶ cm²/sec²−K.

Local refractivity can be calculated from radiosonde or other temperature and humidity profiles using:

$$N = 2.87 \times {10}^{6} \frac{{P}_{dry}}{T} + 77.60 \frac{{e}_{vapor}}{T} + 3.739 \times {10}^{5} \frac{{e}_{vapor}}{{T}^{2}}$$

where
P_{dry}=partial pressure of dry air, millibars
eᵥₐₚₒᵣ=partial pressure of water vapor, millibars
T=temperature, Kelvins

Because most radiosondes do not directly measure the presence and density of cloud liquid water, also generated using other sources are profiles of cloud liquid water and the temperature of the base of the cloud when the soundings infer the presence of cloud. Because of the desired spatial and temporal resolution of the atmospheric thermodynamic parameters, frequent high resolution sondes are utilized in the training and test sets of profiles.

The radiosonde set can be specific to a site or climatology or season, or can be broader by including a plurality of sites, climatologies, and/or seasons. In one alternative, other atmospheric profile data such as artificially generated model atmospheres can be used. A segment of the ensemble of sondes or profiles is separated out into a test set for verification and validation of the retrieval method. If there is a shortage of training data from radiosondes and radiometer system data, data from weather models can be utilized.

This training set of correlated observables 99 and retrievables from 95 is then presented to a retrieval method 103, such as the Stuttgart Neural Network Simulator, in a standard feed forward/back propagation artificial neural network training method, to generate the requisite neural networks (retrieval coefficients and/or functions) 105 that relate the observed parameters to the states of the atmosphere. Training is performed until residual errors in the retrieved values as expressed in an objective or cost function are brought below a defined threshold. As applied in this invention, a large ensemble of brightness temperatures correlated to temperature, cloud liquid water, refractivity and pressure profiles are calculated. ANN stage 81 is thus trained to recognize such profiles from the ensemble of brightness temperatures and ancillary observables.

As shown in FIG. 7, real time observables 107 including radiometer observables from central processing 67 of apparatus 15 (brightness temperatures) and measured surface meteorology, cloud base temperature as measured by an infrared noncontact thermometer observing in an atmospheric window between 9.5 and 11.3 microns, and other ancillary observables received through link 63 are presented to retrieval mechanism 109 (such as the selected retrieval coefficients or functions from 105). Mechanism 109 determines and yields the desired thermodynamic profiles 111.

The measurement of the temperature of the underside of cloud, if present, defines the saturation vapor density, and the retrieved temperature profile defines the altitude. Other ancillary data in addition to those previously identified could include data from other systems such as GPS water vapor measurements or models that contain information pertinent to the thermodynamic state of the atmospheres. Weather models such as the Pennsylvania State/NCAR MM5 model can furnish site-specific profiles for training purposes. Such models can portray current meteorological conditions over broad areas, and can additionally be updated and improved in forecast ability with inputs including the observations from the instant radiometer system. Weather satellite information can also be included in the data input 107.

As may be appreciated, the present invention applies methodology to extract information about both water vapor profiles and temperature profiles (among others) from a single band millimeter waveband radiometer. This invention requires only one receiver to profile these parameters by utilizing a waveband that contains sufficient information on these profiles, when properly processed. The radiometer and methods described herein can be utilized in and adapted to a variety of locations.

For example, use of the intense 183.3 GHz water vapor line has been well suited for observation in dry atmospheres such as high latitudes, high altitudes, or desert climates. However its use has been found advantageous in other locations as well utilizing the apparatus and methods herein. In locations where water vapor is more prevalent, the atmosphere becomes opaque near the strong center of the line, but remains translucent on the distant wings of the line. Thus, provided that observations at a sufficient number of frequencies can be made, the opaque region in the center of the line offers the ability to profile the atmospheric temperature utilizing the variable attenuation on and near the center region of the absorption/emission line. Observation of a large number of frequencies adjacent to the translucent wing toward 170 GHz or 200 GHz accommodates the ability to profile water vapor by determining its pressure broadened profile from these measurements on the far wing of the line. Likewise, cloud liquid water profiles can be determined using such observations.

Previously the value of taking more than only a small number of sample frequencies on the wing of the water vapor line (in the 170 GHz or 200 GHz region for the 183 GHZ water vapor line) was unrecognized for dual parameter profiling. A plurality of observing frequencies in the selected waveband will be sufficient to extract most information on the vertical distribution of water vapor from a single waveband for most atmospheric states at most locations, with the ensemble of frequencies differing for different locations and for differing weather conditions. To extract both temperature and water vapor profiles from the same waveband requires a plurality (at least about 10 or more) frequencies for each of these two parameters (for example, ten frequencies at 170 GHz and higher for water vapor and ten frequencies at 183.3 GHz and lower for temperature). Further, hyperspectral sampling, or sampling at more frequencies than might be required for a given atmospheric state, ensures that maximum information is extracted from all atmospheric weather states encountered. Utilization of frequency agile methods (synthesis for example) in radiometer construction accommodates maximization of frequency readings across a single millimeter waveband.

Because the artificial neural network (ANN) is trained by being presented atmospheric states and a large number of corresponding forward modeled brightnesses that span the possible states of moist atmospheres and their temperature profiles and then learns to recognize these various states from the information contained in the large number of brightness temperature observations, the ANN has the ability to discern these distinctly different profile types from the radiometer brightness and ancillary surface meteorology. The pressure broadened far wing of the line has information on the water vapor profile, whereas the region on and adjacent to the line center that is saturated contains the temperature profile information, with overlapping information between these two regions. Saturation means that the atmosphere is opaque in this region on and near the line center, so that as the radiometer observes closer to line center, the signal originates from regions closer to the radiometer. The translucent wing of the water vapor line allows the cosmic background to be a source and the intervening atmosphere is treated as a lossy intervening medium, thereby allowing determination of the line shape. Having the capability of observing at a large number of input frequencies from the selected waveband adjacent to the water vapor line center and presenting the observations to the ANN allows sufficient degrees of freedom for the ANN to separate out information and determine profiles of interest, for example temperature, water vapor, and liquid water as well as other profiles such as refractivity.

What is claimed is:

1. A method for determination of selected of atmospheric characteristics utilizing signals from a passive radiation emission measurement device comprising the steps of:
remotely receiving a large number of frequencies across a single waveband in the region of selected predictable atmospheric millimeter wave water vapor emission line at the measurement device and providing output indicative thereof;
processing said output to provide brightness temperature measurement data corresponding to said output; and
processing said measurement data to provide thermodynamic profiles of interest.

2. The method of claim 1 wherein the step of processing the measurement data includes training a retrieval mechanism utilizing selected ones of correlated atmospheric observables corresponding to profiles of selected atmospheric parameters, and applying said retrieval mechanism to said measurement data.

3. The method of claim 1 wherein the step of processing the measurement data includes training a retrieval mechanism by presenting an artificial neural network with atmospheric states data and corresponding forward modeled brightness temperatures that span possible atmospheric states of interest.

4. The method of claim 1 wherein the step of remotely receiving includes receiving a first plurality of frequencies near the center of said selected predictable atmospheric millimeter wave water vapor emission line and a second plurality of frequencies spaced from said center of said selected predictable atmospheric millimeter wave water vapor emission line at a wing of said waveband.

5. The method of claim 4 wherein said selected predictable atmospheric millimeter wave water vapor emission line is a water vapor line at 183.3 GHz and wherein said first plurality of frequencies extends either down from about 183.3 GHz or up from 183.3 GHz and wherein said second plurality of frequencies extends either up from about 170 GHz or down from about 200 GHz, respectively.

6. The method of claim 1 wherein the step of remotely receiving includes observing frequencies off zenith and at zenith and wherein the step of processing said measurement data includes processing into at least one of zenithal or off-zenithal profiles of interest.

7. The method of claim 1 further comprising the steps of receiving surface meteorological measurement data in addition to said brightness temperature measurement data.

8. The method of claim 7 wherein said thermodynamic profiles of interest include at least some of tropospheric temperature, water vapor density, relative humidity, cloud liquid water, pressure, and refractivity.

9. The method of claim 1 wherein the step of receiving a large number of frequencies includes utilizing one of frequency agile synthesizer-based direct downconversion architecture or filterbank architecture at the device.

10. An apparatus for passive tropospheric measurement utilizing a single band of frequencies on and adjacent to a selected millimeter wave water vapor line comprising:
a single millimeter wave emission receiver for sensing signals indicative of brightness temperatures in a millimeter waveband in the region of a selected predictable atmospheric thermal radiation emission line and providing output signals indicative thereof;
a link for connection with various data sources selected from a plurality of available sources to receive data signals therefrom;
a processor receiving and processing said output signals from said receiver and said data signals at said link, said processor including a trainable retrieval stage for training and applying retrieval coefficients or functions to processed signals and responsive thereto obtaining an output indicative of selected atmospheric characteristics of interest; and
output means associated with said processor for communicating said output.

11. The apparatus of claim 10 wherein said receiver is characterized by frequency agile synthesizer-based tuning or filterbank architecture manipulation across said waveband with double sideband downconversion architecture, said receiver tunable from about 170 GHz to 183.3 GHz and/or from 183.3 GHz to about 200 GHz.

12. The apparatus of claim 10 wherein said retrieval stage of said processor includes any of linear regression processing, Bayesian maximum probability processing, maximum likelihood processing, nonlinear regression processing, Newtonian iteration processing, direct physical processing.

13. The apparatus of claim 10 wherein said receiver includes a mirror and antenna system capable of observation at angles off zenith as well as at the zenith under control of said processor to thereby increasing the number of independent measurements and resolution of retrieved atmospheric characteristics of interest.

14. A method for making passive tropospheric measurements utilizing a single band of frequencies on and adjacent to a selected millimeter wave water vapor line comprising the steps of:
remotely receiving a large number of frequencies across a single millimeter waveband adjacent to a selected predictable atmospheric wave water vapor emission line at the measurement device and providing output indicative thereof;
processing said output to provide brightness temperature measurement data corresponding to said output;
collecting training sets including thermodynamic profiles and modeled radiometer correlated observables;
training a retrieval method utilizing said training sets; and
processing said measurement data utilizing said retrieval method to provide thermodynamic profiles of interest.

15. The method of claim 14 wherein said thermodynamic profiles include composite variables comprising product, sum, and/or quotient of quantities whose characteristics can be observed or otherwise determined by radiometers.

16. The method of claim 15 wherein said composite variables include T*alpha variables.

17. The method of claim 14 wherein said training set observables include an ensemble of radiometric and ancillary atmospheric observables including brightness temperatures, surface meteorology, and other correlated measurable parameters, and wherein said training set profiles include at least some of correlated atmospheric profiles of temperature, water vapor, relative humidity, cloud liquid, pressure, and refractivity matching said observables.

18. The method of claim 14 further comprising the steps of receiving surface meteorological measurement data and processing said measurement data to further refine said profiles of interest, and wherein said thermodynamic profiles of interest include temperature, water vapor, relative humidity, pressure, refractivity, and cloud liquid profiles.

19. The method of claim 14 wherein said predictable atmospheric wave water vapor emission line is at one of 183.3 GHz, 325 GHZ, 390 GHz, 449 GHz, or 557 GHz.

20. The method of claim 14 wherein said training sets further include any of a priori climatological and historical data, historical data from ancillary observing systems, physical modeling data, GPS path delay data, noncontact thermometer data, surface meteorology data from radiosondes, satellites and ground based observations, and time series of these data.
